(19) United States
(12) Patent Application Publication
(10) Pub. No.: US 2013/0083060 A1
(43) Pub. Date: Apr. 4, 2013

(54) Layers of a User Interface based on Contextual Information

(71) Applicants: Richard James Lawson, Santa Clara, CA (US); Eric Freedman, Austin, TX (US); Marguerite Letulle, San Mateo, CA (US); Ranjit Sidhu, Sunnyvale, CA (US); Chandar Kumar Oddiraju, Santa Clara, CA (US); Lee Fastenau, Austin, TX (US); Brian Romanko, Austin, TX (US)

(72) Inventors: Richard James Lawson, Santa Clara, CA (US); Eric Freedman, Austin, TX (US); Marguerite Letulle, San Mateo, CA (US); Ranjit Sidhu, Sunnyvale, CA (US); Chandar Kumar Oddiraju, Santa Clara, CA (US); Lee Fastenau, Austin, TX (US); Brian Romanko, Austin, TX (US)

(21) Appl. No.: 13/248,860

(22) Filed: Sep. 29, 2011

(51) Int. Cl. G09G 5/377

(52) U.S. Cl. 345/630

(57) ABSTRACT

A device to identify display parameters for layers of a user interface based on contextual information associated with an environment of the device, determine which of the layers are to be visible on the user interface based on the display parameters, and render the user interface on a display component to include the visible layers based on the display parameters.

### BACKGROUND

A user interface for a device can be rendered on a display component. The user interface can include one or more layers to display visual content for a user to view or interact with. The visual content displayed on the layers are frequently based on predefined information stored on a file of the device. The displayed visual content continues to be the same until the user or the device changes a file used to render the layers with different predefined information.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device accessing contextual information associated with an environment of the device according to an example.

FIG. 2 illustrates a display component rendering a user interface according to an example.

FIG. 3 illustrates a block diagram of a device identifying display parameters based on contextual information and rendering layers of a user interface according to an example.

FIG. 4 illustrates an interface application on a device and the interface application stored on a removable medium being accessed by the device according to an example implementation.

FIG. 5 is a flow chart illustrating a method for managing a device according to an example.

FIG. 6 is a flow chart illustrating a method for managing a device according to another example.

### DETAILED DESCRIPTION

A device can access contextual information associated with an environment of the device. The environment includes a location of where the device is located and/or an area around the device. In one embodiment, the contextual information includes information, such as a current time and/or a current date of the location of the device. In another embodiment, the contextual information includes information, such as a weather forecast for the location of the device and/or an area around the device. In other embodiments, the contextual information can include additional details and/or information of the environment, such as whether any activity is detected around the device.

Using the contextual information, the device can identify display parameters for layers of a user interface. The user interface can be a background, wallpaper, screensaver, and/or application of the device made up of layers. For the purposes of this application, a layer can be a transparent Cel (celluloid) of the user interface which visual information can be rendered on based on display parameters corresponding to each layer. For example, the display parameters can specify what to include in a layer, when to render a layer, and/or how visual information of the layer operates or responds based on the contextual information. Using the identified display parameters, the device can determine which of the layers are to be visible on the user interface and the device can render the user interface on a display component to include the visible layers.

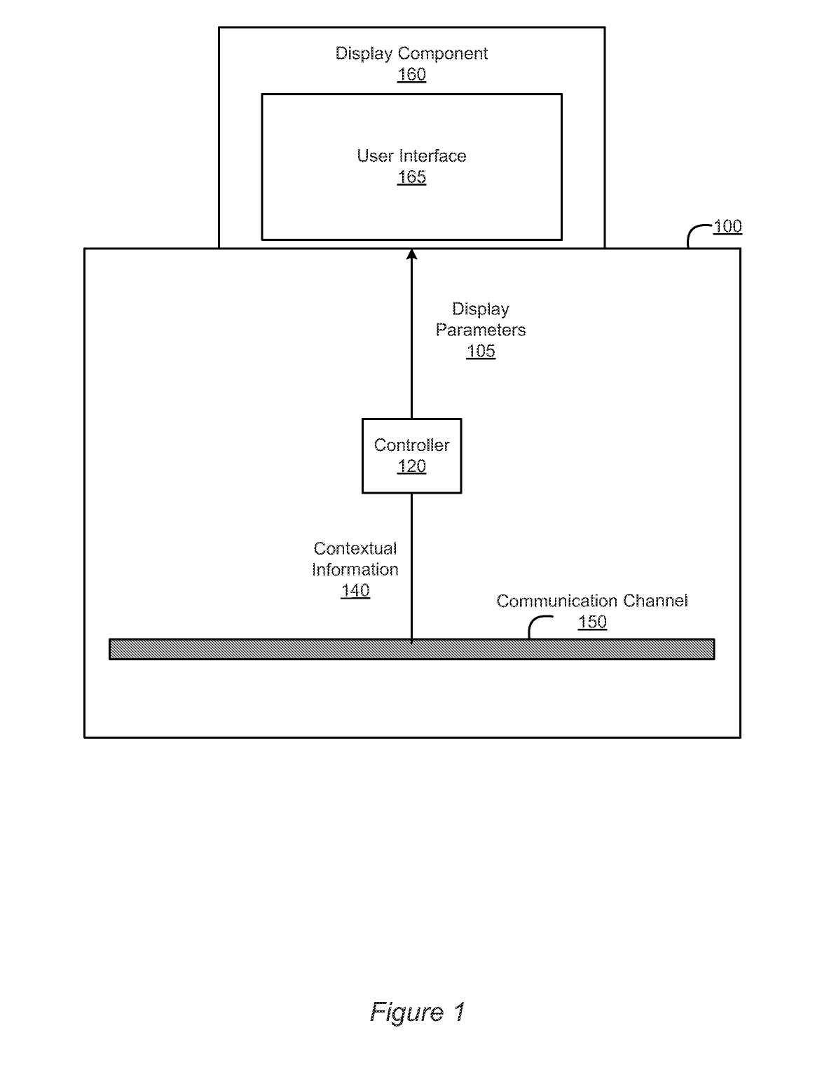

FIG. 1 illustrates a device 100 accessing contextual information 140 associated with an environment of the device 100 according to an example. The device 100 can be a laptop, a notebook, a tablet, a netbook, an all-in-one system, and/or a desktop. In another embodiment, the device 100 can be a cellular device, a PDA (Personal Digital Assistant), an E (Electronic)-Reader, and/or any additional device which can access contextual information 140 and manage the device 100 with the contextual information 140.

The device 100 includes a controller 120, a display component 160, and a communication channel 150 for components of the device 100 to communicate with one another. In other embodiments, the device 100 includes an interface application which can be utilized independently and/or in conjunction with the controller 120 to manage the device 100 with the contextual information 140. The interface application can be a firmware or application which can be executed by the controller 120 from a non-transitory computer readable memory of the device 100.

The contextual information 140 includes information associated with the environment of the device 100. The environment includes a location of the device 100 and/or an area around the device 100. In one embodiment, the contextual information 140 can be a time and/or date of where the device 100 is located, a weather forecast for the area around of the device 100, whether a user is around the device 100, and/or whether any activity is detected around the device 100. The activity can include whether music is being played around the device 100 and/or whether a user is interacting with the device 100. In other embodiments, the contextual information 140 includes additional information associated with the environment of the device 100 in addition to and/or in lieu of those noted above.

When accessing contextual information 140, the controller 120 and/or the interface application can access information which may be local to the device 100, such as a current time and/or current date listed by the device 100. In another embodiment, the controller 120 and/or the interface application can access contextual information 140 by receiving information from another device, such as a weather forecast. In other embodiments, when accessing contextual information 140, the device 100 can detect information or activity from the area around the device 100. The device 100 can include a hardware component, such as a communication component to access the contextual information 140 from another device and/or a sensor for the device 100 to detect the contextual information 140 from the environment of the device 100.

The detected contextual information 140 can be used by the controller 120 and/or the interface application to identify display parameters 105 for layers of a user interface 165. For the purposes of this application, a display parameter 105 includes information associated with a corresponding layer and specifies what visual information can be rendered on the corresponding layer. The display parameter 105 can include data, files, values, and/or information for the controller 120 and/or the interface application to use when determining whether to render a corresponding layer and when determining what visual information is to be rendered on a visible layer of the user interface 165.

The user interface 165 includes one or more layers which display visual information, such as images, videos, and/or alphanumeric characters. For the purposes of this application, the layers are transparent Cels (celluloids) of the user interface 165 which are rendered by the controller 120 and/or the interface application to overlap one another and to display visual information as part of the user interface 165. In one embodiment, the user interface 165 can be wallpaper, a screen saver, and/or an application of the device 100.

When identifying display parameters 105 for a corresponding layer, the controller 120 and/or the interface application initially access predefined information of the corresponding layer. The predefined information can specify under what conditions the corresponding layer will be visible, a location of the user interface 165 for the corresponding layer to be rendered, if visual information on the corresponding layer can be animated, under what conditions the visual information will be animated, how the visual information can be animated, and if the visual information of the corresponding layer responds to information detected from the environment around the device 100.

The controller 120 and/or the interface application compare the contextual information 140 to the predefined information of a corresponding layer to determine if the corresponding layer will be visible on the user interface. A corresponding layer will be determined to be rendered and made visible if the contextual information 140 matches the specified conditions of the corresponding layer being visible. Additionally, a corresponding layer will not be rendered and will be hidden or transparent if the contextual information 140 does not match the specified conditions of the corresponding layer being visible.

In one embodiment, the controller 120 and/or the interface application can determine to render or not render a layer of the user interface 165 based on a current time and/or a current date. In another embodiment, the controller 120 and/or the interface application can determine to render or not render a layer of the user interface 165 based on a current location of the device 100. The controller 120 and/or the interface application can repeat this for each layer to determine which of the layers are to be visible on the user interface 165.

Once the controller 120 and/or the interlace application have determined which layers are to be rendered and visible on the user interface 165, the controller 120 and/or the interface application proceed to render the user interface 165 on the display component 160 to include the visible layers based on each layer's corresponding display parameters 140. The display component 160 is a hardware output component which can display the user interface 165 to include the visible layers for a user of the device 100 to view and/or interact with. In one embodiment, the display component 160 is a LCD (liquid crystal display), a LED (light emitting diode) display, a CRT (cathode ray tube) display, a plasma display, a projector and/or any additional device configured to display the user interface 165.

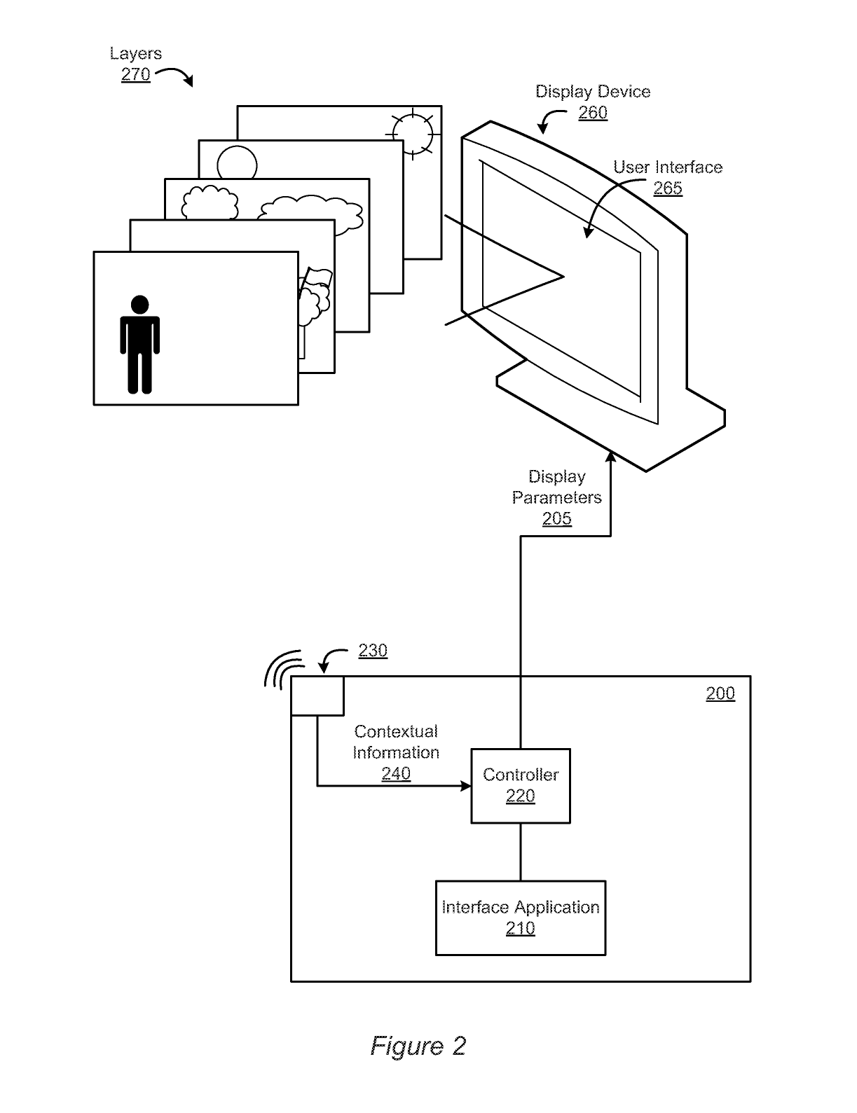

FIG. 2 illustrates a display component 260 displaying a user interface 265 according to an example. As noted above, the display component 260 is an output device, such as a LCD, a LED display, a CRT display, a plasma display, a projector and/or any additional device configured to display a user interface 265. The user interface 265 can be wallpaper, a screen saver, and/or an application of the device 200 which displays visual information as one or more images, videos, and/or alphanumeric characters for a user of the device 200 to view and/or interact with.

As shown in FIG. 2, the user interface 265 includes overlapping layers 270 which display the visual information. As noted above, the layers 270 are transparent Cels of the user interface 265. In one embodiment, the visual information for one or more layers 270 can be static. In another embodiment, the visual information for one or more layers 240 can be animated. In other embodiments, the visual information can be interactive. Additionally, as shown in the present embodiment, the visual information rendered on one layer of the user interface 265 can differ from the visual information rendered on another layer of the user interface 265.

As shown in FIG. 2, a first layer can include an image of a sun, a second layer can include an image of a moon, a third layer can include images of clouds, a fourth layer can include images of trees and a flag, and a fifth layer can include images of a person. In other embodiments, the user interface 265 can include additional layers 270 and/or include additional visual information on the layers 270 in addition to and/or in lieu of those noted above and displayed in FIG. 2. The controller 220 and/or the interface application 210 can determine whether each of the layers 270 will be visible or hidden based on display parameters 205. Each of the layers 270 determined to be visible can be rendered by the controller 220 and/or the interface application 210 based on information specified by the corresponding layer's 270 display parameters 205. Additionally, each of the layers 270 determined to be hidden or transparent are not rendered by the controller 220 and/or the interface application 210.

As noted above, display parameters 205 for the layers 270 are based on contextual information 240 associated with an environment of the device 200. The contextual information 240 corresponds to information associated with a location of the device 200 and/or an area around the device 200. In one embodiment, the contextual information 240 includes a current time and/or current date corresponding to the location of the device 200. In another embodiment, the contextual information 240 includes a weather forecast for an area around the device 200. In other embodiments, the contextual information 240 includes information any activity detected around the device 200. The activity can be whether a user is present around the device 200, whether a user is interacting with the device 200, whether any music is being played around the device 200, and/or any additional activity around the device 200.

In one embodiment, when accessing contextual information 240, the controller 220 and/or the interface application 210 access information local to the device 200, such as a current time and/or current date specified by the device 200. The current time and/or current date can be accessed from the controller 220, a clock of the device 200, a BIOS (Basic Input/Output System), and/or an operating system of the device 200.

In another embodiment, as illustrated in Figure, the device 200 can additionally include a component 230 to access and/or detect the contextual information 240. The component 230 can include a communication component which can couple with another device to access and/or receive the contextual information 240 from another device. The communication component is a hardware component, such as a network interface component, a wireless radio, an infrared component, and/or a Bluetooth component, which can couple with another device and receive contextual information 240 of the environment from another device. The contextual information 240 from another device can include a weather forecast for the environment of the device 200, a location of the device 200, and/or any additional contextual information 240 which can be received from another device.

In another embodiment, the component 230 can include a sensor. The sensor is a hardware component of the device 200 which can detect information from the environment of the device 200. The sensor can be an image capture component, a microphone, a global positioning system receiver, and/or an input component such as a touch screen, a mouse, or a keyboard. The sensor can detect for audio activity, visual activity, physical activity, and/or any additional activity from the environment of the device 200.

The audio activity can be whether any music is being played around the device 200. Additionally, the visual activity can include whether a user is present around the device 200 and/or whether the user is interacting with the device 200. Further, the physical activity can include whether a user is detected to be interacting with the device 200 and/or the user interface 265 of the device 200 through an input component of the device 200. In other embodiments, the controller 220 and/or the interface application 210 can access contextual information 240 using additional means and/or components in addition to and/or in lieu of those noted above and illustrated in FIG. 2.

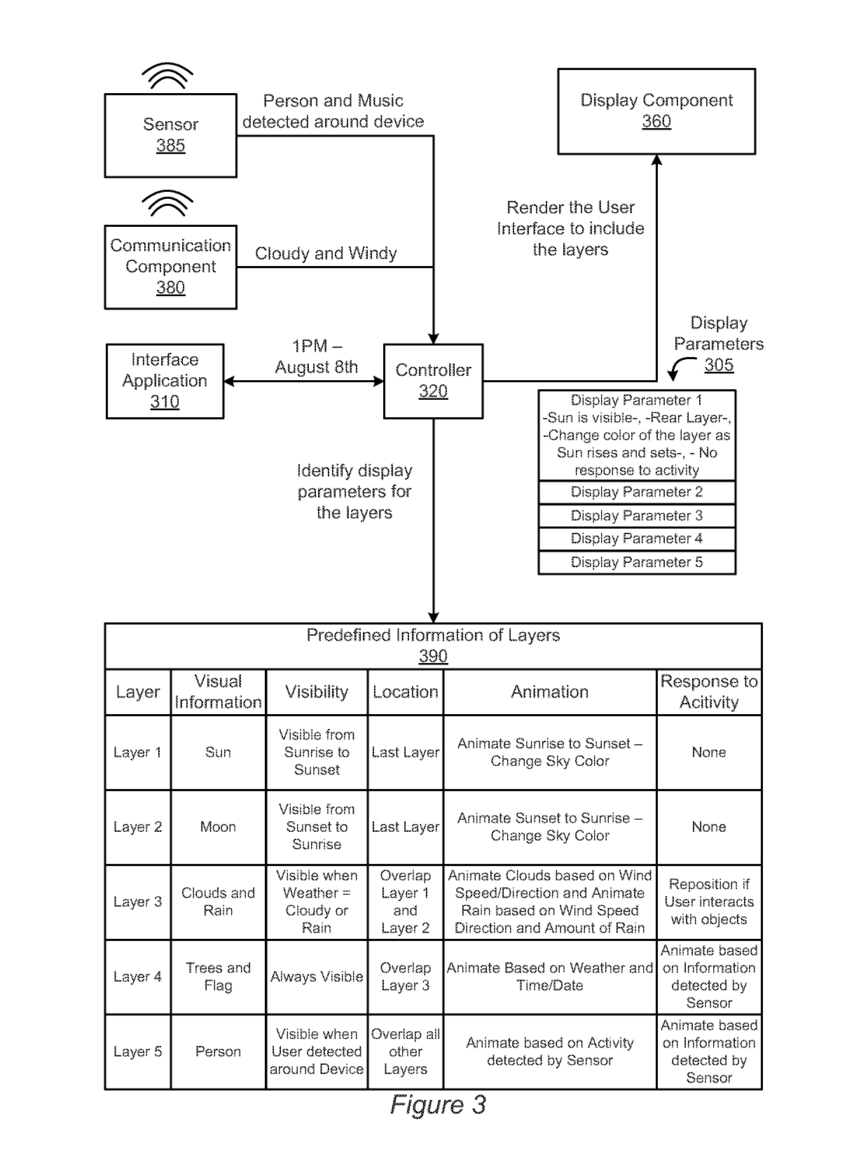

FIG. 3 illustrates a block diagram of a device identifying display parameters 305 in response to accessing contextual information and rendering layers of a user interface based on the display parameters 305 according to an example. The controller 320 and/or the interface application 310 identify display parameters 305 for each layer of the user interface based on accessed contextual information associated with the environment of the device. As noted above, a display parameter 305 includes information associated with a corresponding layer and specifies what visual information can be rendered on the corresponding layer. The display parameters 305 can be stored as data, files, values, and/or information for the controller 320 and/or the interface application 310 to use when rending a corresponding layer of the user interface.

When identifying display parameters 305 for a corresponding layer, the controller 320 and/or the interlace application 310 compare accessed contextual information to predefined information 390 of a corresponding layer to determine if the corresponding layer will be visible on the user interface. Additionally, the display parameters 305 are used to determine when, where, and/or how visual information is to be rendered on a visible corresponding layer. As illustrated in FIG. 3, a sensor 385 has detected music playing around the device. Additionally, a communication component 380 has received a weather forecast for area around the device from another device. Further, the controller 320 and/or the interface application 310 determine that a current time and current date of the location of the device is 1 PM, August 8^{th}.

The controller 320 and/or the interface application 310 compare the contextual information (music is playing, weather forecast is sunny and windy, and the current time and date is 1 PM, August 8^{th}) to the predefined information 390 of Layer 1 (Layer 1 includes a Sun, the Sun is visible between sunrise and sunset, Layer 1 is to be the last layer, Layer 1 is to be animated from sunrise to sunset, and the Sun does not respond to activity detected around the device). Based on the contextual information of the current time and/or current date, the controller 320 and/or the interface application 310 identify Display Parameter 1 corresponding to Layer 1 is to be: the Sun is visible, Layer 1 is positioned as the rear layer, animate Layer 1 by changing a color of the layer as the Sun rises and sets, and Layer 1 does not respond to any detected activity.

The controller 320 and/or the interface application 310 also compare the contextual information to the predefined information 390 of Layer 2 (Layer 2 includes a Moon, the Moon is visible from sunset to sunrise, Layer 2 is to be the last layer, Layer 2 is to be animated from sunset to sunrise, and the Moon does not respond to activity detected around the device). Based on the contextual information of the current time and/or current date, the controller 320 and/or the interface application 310 identify Display Parameter 2 for Layer 2 to be: the Moon is currently not visible, Layer 2 is positioned to be the rear layer, animate Layer 2 by changing a color of the layer as the Moon rises and sets, and Layer 2 does not respond to any detected activity.

Additionally, the predefined information 390 of Layer 3 (Layer 3 includes Clouds and/or Rain, the Clouds are visible when the weather forecast is be cloudy and the Clouds and Rain are both visible when the weather forecast is rainy, Layer 3 is to overlap Layer 1 and 2, the Clouds are to be animated based on a speed and/or direction of wind and the Rain will be animated based on wind speed and/or an amount of Rain, and the Cloud and/or Rain can reposition in response to activity being detected around the device. Based on the contextual information of the weather forecast, Display Parameter 3 for Layer 3 is identified to be: Clouds are visible and Rain is not visible, Layer 3 is positioned to overlap Layer 1 and 2, animate Layer 3 by repositioning the Clouds based on a direction and speed of the wind, and Layer 3 responds to physical activity of a user interacting with the Clouds.

Further, by comparing the contextual information to the predefined information of Layer 4, the controller 320 and/or the interface application 310 identify that Display Parameter 4 for Layer 4 includes: Trees and Flag are visible, Layer 4 is positioned to overlap Layer 3, animate the Trees and the Flag based on direction and speed of wind, and Layer 4 responds to visual activity detected around the device. In addition, the controller 320 and/or the interface application 310 identify that Display Parameter 5 for Layer 5 includes: the Person is visible, Layer 5 overlaps all of the other layers, the Person animates due to Music being detected around the device, and Layer 5 responds to activity detected around the device.

In response to identifying corresponding display parameters 305 for each layer, the controller 320 and/or the interface application 310 identify which of the layers to render. Because Layer 2 is specified by its corresponding display parameter to be visible from sunset to sunrise, the controller 320 and/or the interface application 310 determine to not render Layer 2. As a result, Layer 2 appears to be hidden. Additionally, because the weather forecast does not include Rain, the controller 320 and/or the interface application 310 partially render Layer 2 to display the Clouds, but not the Rain.

The controller 320 and/or the interface application 310 proceed to render the remaining visible layers (Layer 1, Layer 3, Layer 4, and Layer 5) based on their corresponding display parameters 305. In one embodiment, the layers are rendered independently from one another and are then overlapped by the controller 320 and/or the interface application 310. As noted above, the visible layers are rendered as part of the user interface on the display component 360.

In other embodiments, the user interface can include additional layers and the additional layers can be rendered based on additional display parameters in addition to and/or in lieu of those noted above and illustrated in FIG. 3. Additionally, the controller 320 and/or the interface application 310 can continue to access, receive, and/or detect new or updated contextual information. The controller 320 and/or the user interface 310 can then update the display parameters 305 and update the corresponding layers with the updated display parameters 305.

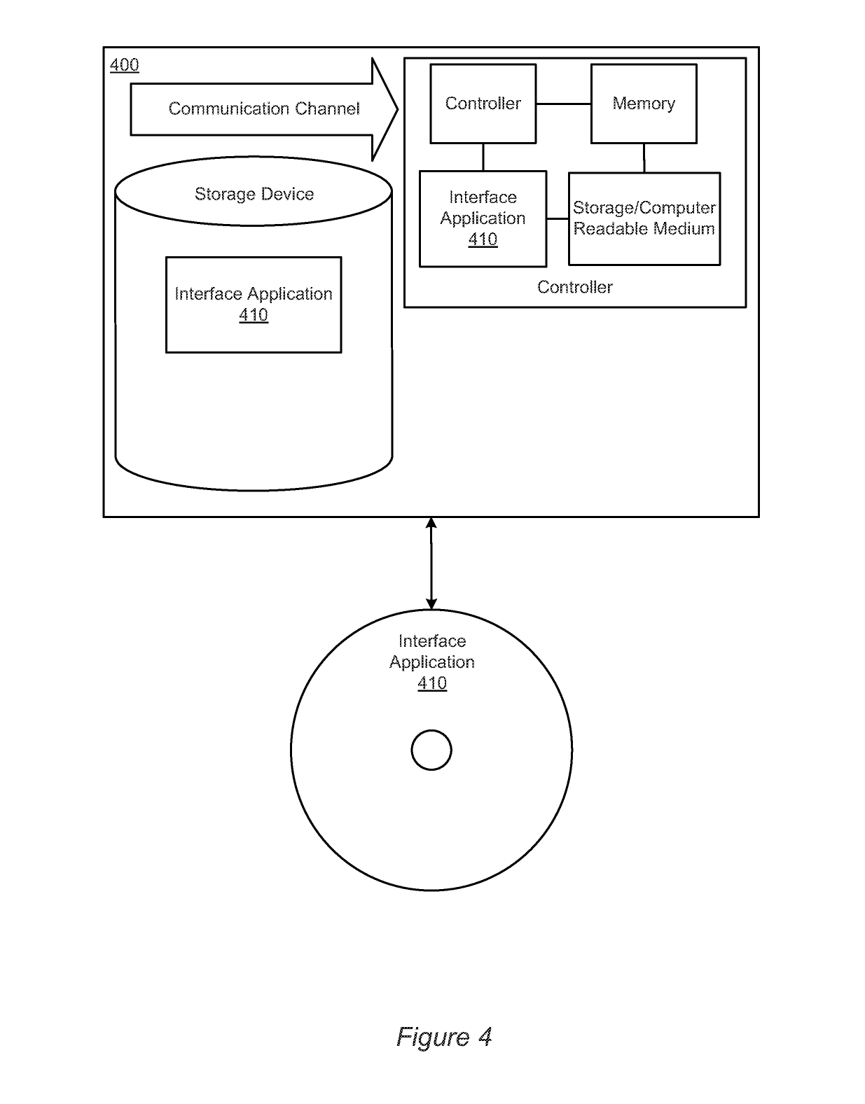

FIG. 4 illustrates an interface application 410 on a device 400 and the interface application 410 stored on a removable medium being accessed by the device 400 according to an embodiment. For the purposes of this description, a removable medium is any tangible apparatus that contain, stores, communicates, or transports the application for use by or in connection with the device 400. As noted above, in one embodiment, the interface application 410 is firmware that is embedded into one or more components of the device 400 as ROM. In other embodiments, the interface application 410 is an application which is stored and accessed from a hard drive, a compact disc, a flash disk, a network drive or any other form of computer readable medium that is coupled to the device 400.

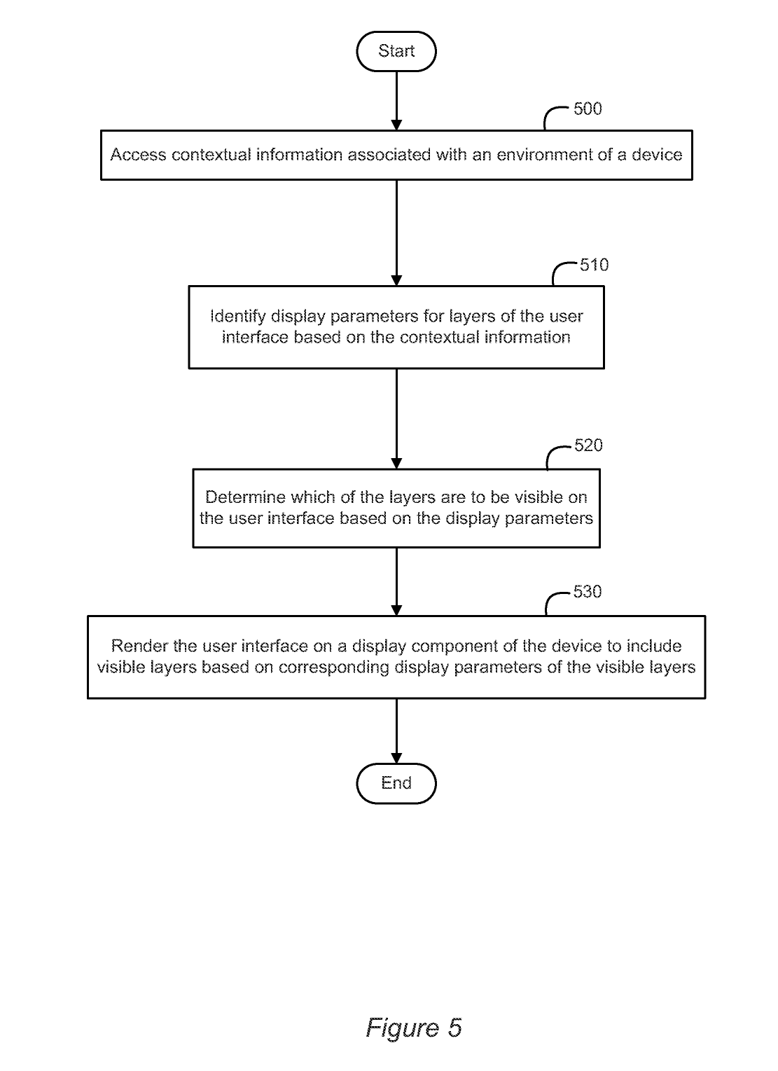

FIG. 5 is a flow chart illustrating a method for managing a device according to an example. A controller and/or interface application can be utilized independently and/or in conjunction with one another to manage the device. The controller and/or the interface application initially access contextual information associated with an environment of the device at 500. The contextual information includes information corresponding to and/or associated with the environment of the device. In one embodiment, the contextual information, such as a current time and/or current date, can be locally access on the device. In another embodiment, the contextual information, such as a weather forecast, can be remotely accessed and/or received from another device with a communication component of the device. In other embodiments, the contextual information can be detected from the environment of the device with a sensor. The sensor can detect around the device for activity in the form of audio, visual, and/or physical activity from the environment of the device.

In response to accessing contextual information, the controller and/or the interface application can proceed to identify display parameters for layers of a user interface based on the contextual information at 510. As noted above, the display parameters include information of a corresponding layer to be used by the controller and/or the interface application when rendering the user interface. The controller and/or the interface application can compare the contextual information to predefined information of the layers to identify display parameters for each of the layers.

Using the display parameters, the controller and/or the interface application can determine which of the layers are visible and to be rendered at 520. As noted above, a layer may be visible at certain times and/or at certain times. As a result, based on contextual information, such as a time, date, and/or location, the corresponding layer may not be visible. If not visible, the controller and/or the interface application will not render the corresponding layer. The controller and/or the interface application will then proceed to render the user interface on the display component to include the visible layers based on their corresponding display parameters at 530. The method is then complete. In other embodiments, the method of FIG. 5 includes additional steps in addition to and/or in lieu of those depicted in FIG. 5.

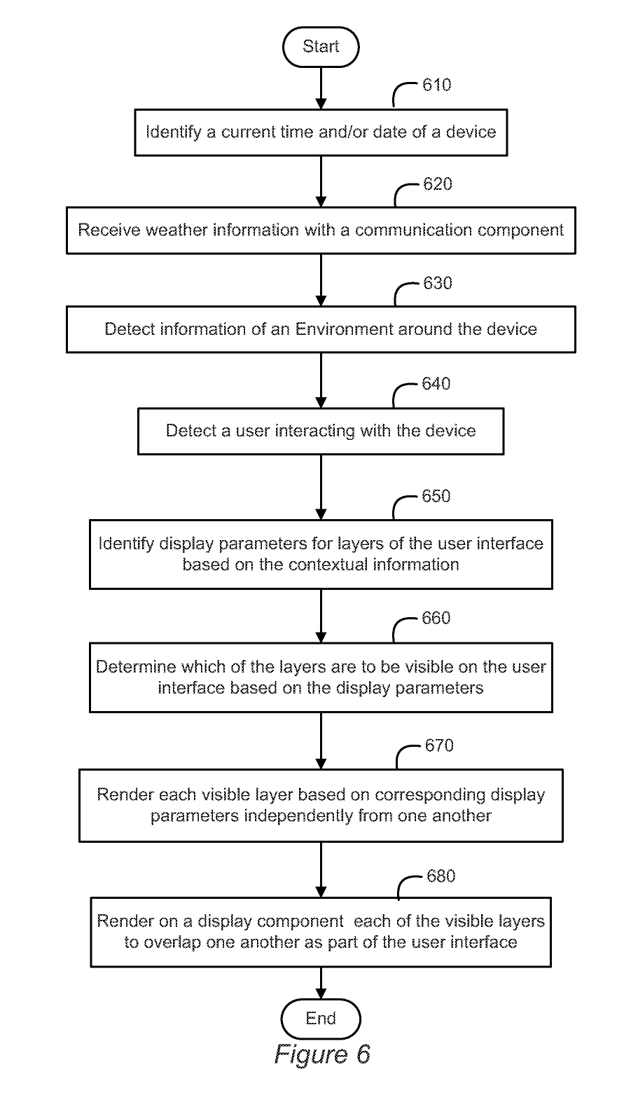

FIG. 6 is a flow chart illustrating a method for managing a portable device according to an example. The controller and/or the interface application initially access contextual information by accessing local information, accessing information from another device, and/or detecting information from the environment of the device. The controller and/or the interface application can access local information on the device to identify a current time and/or current date of the device at 610.

In one embodiment, the device can includes a communication component. The controller and/or the interface application can use the communication component to receive and/or access weather information from another device at 620. In another embodiment, the device can further include a sensor. The sensor can be used by the controller and/or the interface application to detect information from the environment of the device at 630. The information can include a location of the device and/or whether any visual, audio, and/or physical activity is detected around the device. The controller and/or the interface application detect for any visual, audio, and/or physical activity when detecting for one or more people interacting with the device of the device at 640.

Using the contextual information, the controller and/or the interface application identify display parameters for layers of the user interface based on the contextual information at 650. As noted above, a display parameter includes information associated with a corresponding layer and specifies what visual information can be rendered on the corresponding layer. The display parameters can be stored as data, files, values, and/or information for the controller and/or the interface application to use when rending a corresponding layer of the user interface. The user interface can be a wallpaper, screensaver, and/or application of the device. Using the information listed within the corresponding display parameters, the controller and/or the interface application can determine which of the layers are to be visible and/or rendered on the user interface at 660.

The controller and/or the interface application can then render the layers identified to be visible on the display component based on their corresponding display parameters at 680. As noted above, the layers can be rendered by the controller and/or the interlace application independently from one another and can be rendered to overlap one another. As any new contextual information is accessed, received, and/or detected by the device, controller and/or the user interface can update the display parameters and update the corresponding layers with the updated display parameters. The method is then complete. In other embodiments, the method of FIG. 6 includes additional steps in addition to and/or in lieu of those depicted in FIG. 6.

What is claimed is:

1. A device comprising:
a display component to display a user interface; and
a controller to:
identify display parameters for layers of the user interface based on contextual information associated with an environment of the device;
determine which of the layers are to be visible on the user interface based on the display parameters; and
render the user interface on the display component to include visible layers based on corresponding display parameters of the visible layers.

2. The device of claim 1 further comprising a communication component to receive the contextual information associated with the environment.

3. The device of claim 2 wherein the communication component includes at least one of a network interface component, an Infrared component, and a Bluetooth component.

4. The device of claim 1 further comprising a sensor to detect the contextual information associated with the environment.

5. The device of claim 4 wherein the sensor additionally detects for a user interacting with the user interlace.

6. The device of claim 4 wherein the sensor includes at least one of an image capture component, a microphone, global positioning system receiver, and an input component.

7. The device of claim 1 wherein the display parameters identify at least one of whether the corresponding layer is visible, a time to render the corresponding layer, a location of the user interface to render the corresponding layer, whether the corresponding layer is animated, a direction which the corresponding layer repositions, and a speed of the corresponding layer repositioning.

8. A method for managing a device comprising:
accessing contextual information associated with an environment of the device;
identifying display parameters for layers of the user interface based on the contextual information;
determining which of the layers are to be visible on the user interface based on the display parameters; and
rendering the user interface on a display component of the device to include visible layers based on corresponding display parameters of the visible layers.

9. The method for managing the device of claim 8 wherein accessing contextual information associated with the environment of the device includes receiving weather information with a communication component of the device.

10. The method for managing the device of claim 8 wherein accessing contextual information associated with the environment of the device includes a sensor detecting information from the environment of the device.

11. The method for managing the device of claim 8 wherein accessing contextual information associated with the environment of the device includes a sensor detecting a user interacting with the user interface.

12. The method for managing the device of claim 8 wherein accessing contextual information associated with the environment of the device includes a sensor capturing an image of the environment.

13. The method for managing the device of claim 8 wherein accessing contextual information associated with the environment of the device includes identifying at least one of a current time and a current date.

14. The method for managing the device of claim 13 wherein determining which of the layers are to be visible on the user interface is based on at least one of the current time and the current date.

15. The method for managing the device of claim 8 wherein identifying display parameters includes determining whether to animate a corresponding layer.

16. The method for managing the device of claim 15 wherein determining whether to animate a corresponding layer includes determining a direction to reposition the corresponding layer and a speed to reposition the corresponding layer.

17. The method for managing the device of claim 8 wherein identifying display parameters includes determining whether the corresponding layer responds to a user interacting with the device.

18. A computer readable medium comprising instructions that if executed cause a controller to:
access contextual information associated with an environment of a device;
identify display parameters for layers of a user interface based on the contextual information;
determine which of the layers are to be visible on the user interface based on the display parameters; and
render the user interface on a display component of the device to include visible layers based on corresponding display parameters of the visible layers.

19. The computer readable medium of claim 18 wherein each of the layers are rendered independently from one another with the display parameters.

20. The computer readable medium of claim 18 wherein rendering the user interface includes rendering the layers to overlap one another.
